(19) United States
(12) Patent Application Publication
(10) Pub. No.: US 2023/0276275 A1
(43) Pub. Date: Aug. 31, 2023

(54) ROUND-TRIP TIME MEASUREMENT PROCEDURE ON RECIPROCAL CROSS-LINK INTERFERENCE MEASUREMENT RESOURCES

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US); Qunfeng HE, San Diego, CA (US)

(21) Appl. No.: 18/003,252

(22) PCT Filed: Aug. 14, 2020
(86) PCT No.: PCT/CN2020/109269

§ 371 Date: Dec. 23, 2022

(51) Int. Cl. H04W 24/08; G01S 13/76; H04W 24/10

(52) U.S. Cl. CPC H04W 24/08; G01S 13/765; H04W 24/10

(57) ABSTRACT

In an aspect, a BS determines a CLI measurement resource configuration associated with first and second UEs, the reciprocal CLI measurement resource configuration comprising resources associated with both a CLI measurement procedure and an RTT measurement procedure between the first UE and the second UE. The BS transmits the reciprocal CLI measurement resource configuration to the first and second UEs. The first and second UEs perform both the CLI measurement procedure and the RTT measurement procedure with the second UE based on the resources associated with the reciprocal CLI measurement resource configuration.

### CROSS-REFERENCE TO RELATED APPLICATIONS

The present application claims priority to International Application No. PCT/CN2020/109269, entitled “ROUND-TRIP TIME MEASUREMENT PROCEDURE ON RECIPRICAL CROSS-LINK INTERFERENCE MEASUREMENT RESOURCES”, filed Aug. 14, 2020, which is assigned to the assignee hereof and is expressly incorporated herein by reference in its entirety.

### BACKGROUND OF THE DISCLOSURE

### 1. Field of the Disclosure

Aspects of the disclosure relate generally to wireless communications and more particularly to a round-trip time measurement procedure on reciprocal cross-link interference (CLI) resources.

### 2. Description of the Related Art

Wireless communication systems have developed through various generations, including a first-generation analog wireless phone service (1G), a second-generation (2G) digital wireless phone service (including interim 2.5G networks), a third-generation (3G) high speed data, Internet-capable wireless service and a fourth-generation (4G) service (e.g., LTE or WiMax). There are presently many different types of wireless communication systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile access (GSM) variation of TDMA, etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large wireless deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

An aspect is directed to a method of operating a first user equipment (UE), comprising receiving a reciprocal cross-link interference (CLI) measurement resource configuration associated with the first UE and a second UE, and performing both a CLI measurement procedure and a round-trip time (RTT) measurement procedure with the second UE based on resources associated with the reciprocal CLI measurement resource configuration.

Another aspect is directed to a method of operating a base station, comprising determining a reciprocal cross-link interference (CLI) measurement resource configuration associated with a first user equipment (UE) and a second UE, the reciprocal CLI measurement resource configuration comprising resources associated with both a CLI measurement procedure and a round-trip time (RTT) measurement procedure between the first UE and the second UE, and transmitting the reciprocal CLI measurement resource configuration to the first UE and the second UE.

Another aspect is directed to a first user equipment (UE), comprising means for receiving a reciprocal cross-link interference (CLI) measurement resource configuration associated with the first UE and a second UE, and means for performing both a CLI measurement procedure and a round-trip time (RTT) measurement procedure with the second UE based on resources associated with the reciprocal CLI measurement resource configuration.

Another aspect is directed to a base station, comprising means for determining a reciprocal cross-link interference (CLI) measurement resource configuration associated with a first user equipment (UE) and a second UE, the reciprocal CLI measurement resource configuration comprising resources associated with both a CLI measurement procedure and a round-trip time (RTT) measurement procedure between the first UE and the second UE, and means for transmitting the reciprocal CLI measurement resource configuration to the first UE and the second UE.

Another aspect is directed to a first user equipment (UE), comprising a memory, at least one communications interface, and at least one processor communicatively coupled to the memory, the at least one communications interface, the at least one processor configured to receive a reciprocal cross-link interference (CLI) measurement resource configuration associated with the first UE and a second UE, and perform both a CLI measurement procedure and a round-trip time (RTT) measurement procedure with the second UE based on resources associated with the reciprocal CLI measurement resource configuration.

Another aspect is directed to a base station, comprising a memory, at least one communications interface, and at least one processor communicatively coupled to the memory, the at least one communications interface, the at least one processor configured to determine a reciprocal cross-link interference (CLI) measurement resource configuration associated with a first user equipment (UE) and a second UE, the reciprocal CLI measurement resource configuration comprising resources associated with both a CLI measurement procedure and a round-trip time (RTT) measurement procedure between the first UE and the second UE, and transmit the reciprocal CLI measurement resource configuration to the first UE and the second UE.

Another aspect is directed to a non-transitory computer-readable medium containing instructions stored thereon, which, when executed, cause a first user equipment (UE) to receive a reciprocal cross-link interference (CLI) measurement resource configuration associated with the first UE and a second UE, and perform both a CLI measurement procedure and a round-trip time (RTT) measurement procedure with the second UE based on resources associated with the reciprocal CLI measurement resource configuration.

Another aspect is directed to a non-transitory computer-readable medium containing instructions stored thereon, which, when executed, cause a base station to determine a reciprocal cross-link interference (CLI) measurement resource configuration associated with a first user equipment (UE) and a second UE, the reciprocal CLI measurement resource configuration comprising resources associated with both a CLI measurement procedure and a round-trip time (RTT) measurement procedure between the first UE and the second UE, and transmit the reciprocal CLI measurement resource configuration to the first UE and the second UE.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an exemplary wireless communications system, according to various aspects.

FIGS. 2A and 2B illustrate example wireless network structures, according to various aspects.

FIGS. 3A to 3C are simplified block diagrams of several sample aspects of components that may be employed in wireless communication nodes and configured to support communication as taught herein.

FIGS. 4A and 4B are diagrams illustrating examples of frame structures and channels within the frame structures, according to aspects of the disclosure.

FIG. 4C illustrates an exemplary PRS configuration for a cell supported by a wireless node.

FIG. 5 is a diagram illustrating an exemplary technique for determining a position of a UE using information obtained from a plurality of base stations.

FIG. 6 is a diagram showing exemplary timings of round-trip-time (RTT) measurement signals exchanged between a base station and a UE, according to aspects of the disclosure.

FIG. 7 illustrates an exemplary wireless communications system according to aspects of the disclosure.

FIG. 8 illustrates an exemplary wireless communications system according to aspects of the disclosure.

FIG. 9 illustrates is an exemplary wireless communications system according to aspects of the disclosure.

FIG. 10 is a diagram showing exemplary timings of RTT measurement signals exchanged between a base station and a UE, according to aspects of the disclosure.

FIG. 11 illustrates a series of symbols associated with an aggressor UE and a victim UE in accordance with other aspects of the disclosure.

FIG. 12 illustrates a series of symbols associated with UEs in accordance with other aspects of the disclosure.

FIG. 13 illustrates a scenario where UE 1 is proximate to UEs 2-4 in accordance with an embodiment of the disclosure.

FIG. 14 illustrates an exemplary method of wireless communication, according to aspects of the disclosure.

FIG. 15 illustrates an exemplary method of wireless communication, according to aspects of the disclosure.

FIG. 16 is a diagram showing exemplary timings of RTT measurement signals exchanged between UEs in accordance with an example implementation of the processes of FIGS. 14-15, respectively, according to aspects of the disclosure.

FIG. 17 is a diagram showing exemplary timings of RTT measurement signals exchanged between UEs in accordance with another example implementation of the processes of FIGS. 14-15, respectively, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular Radio Access Technology (RAT), unless otherwise noted. In general, a UE may be any wireless communication device (e.g., a mobile phone, router, tablet computer, laptop computer, tracking device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a New Radio (NR) Node B (also referred to as a gNB or gNodeB), etc. In addition, in some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission point or to multiple physical transmission points that may or may not be co-located. For example, where the term “base station” refers to a single physical transmission point, the physical transmission point may be an antenna of the base station corresponding to a cell of the base station. Where the term “base station” refers to multiple co-located physical transmission points, the physical transmission points may be an array of antennas (e.g., as in a multiple-input multiple-output (MIMO) system or where the base station employs beamforming) of the base station. Where the term “base station” refers to multiple non-co-located physical transmission points, the physical transmission points may be a distributed antenna system (DAS) (a network of spatially separated antennas connected to a common source via a transport medium) or a remote radio head (RRH) (a remote base station connected to a serving base station). Alternatively, the non-co-located physical transmission points may be the serving base station receiving the measurement report from the UE and a neighbor base station whose reference RF signals the UE is measuring.

An “RF signal” comprises an electromagnetic wave of a given frequency that transports information through the space between a transmitter and a receiver. As used herein, a transmitter may transmit a single “RF signal” or multiple “RF signal s” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

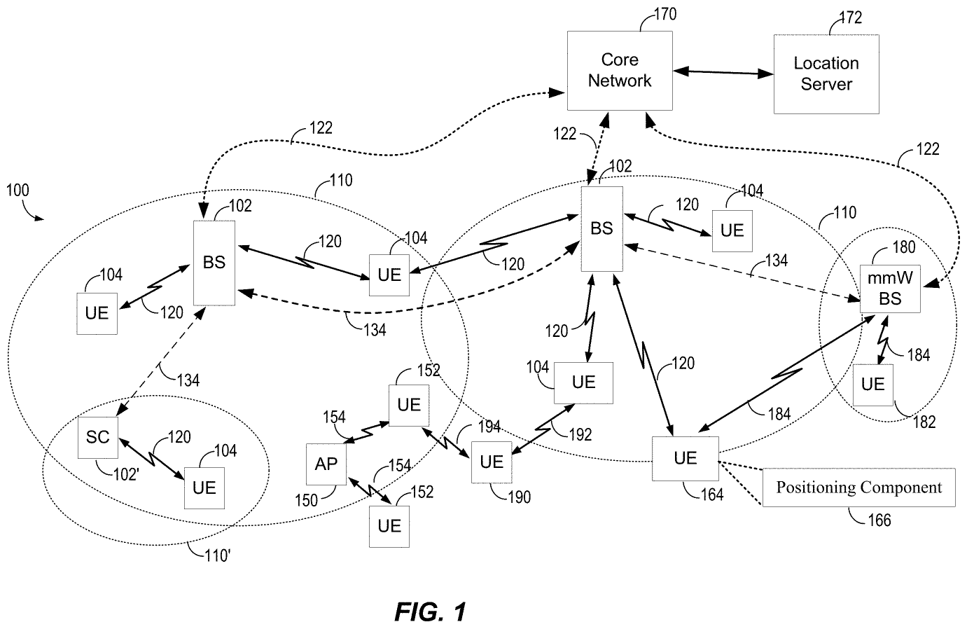

According to various aspects, FIG. 1 illustrates an exemplary wireless communications system 100. The wireless communications system 100 (which may also be referred to as a wireless wide area network (WWAN)) may include various base stations 102 and various UEs 104. The base stations 102 may include macro cell base stations (high power cellular base stations) and/or small cell base stations (low power cellular base stations). In an aspect, the macro cell base station may include eNBs where the wireless communications system 100 corresponds to an LTE network, or gNBs where the wireless communications system 100 corresponds to a 5G network, or a combination of both, and the small cell base stations may include femtocells, picocells, microcells, etc.

The base stations 102 may collectively form a RAN and interface with a core network 170 (e.g., an evolved packet core (EPC) or next generation core (NGC)) through backhaul links 122, and through the core network 170 to one or more location servers 172. In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/NGC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCID), a virtual cell identifier (VCID)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include UL (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to DL and UL (e.g., more or less carriers may be allocated for DL than for UL).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or 5G technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. LTE in an unlicensed spectrum may be referred to as LTE-unlicensed (LTE-U), licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-collocated, meaning that they appear to the receiver (e.g., a UE) as having the same parameters, regardless of whether or not the transmitting antennas of the network node themselves are physically collocated. In NR, there are four types of quasi-collocation (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Receive beams may be spatially related. A spatial relation means that parameters for a transmit beam for a second reference signal can be derived from information about a receive beam for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

In 5G, the frequency spectrum in which wireless nodes (e.g., base stations 102/180, UEs 104/182) operate is divided into multiple frequency ranges, FR1 (from 450 to 6000 MHz), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels. A secondary carrier is a carrier operating on a second frequency (e.g., FR2) that may be configured once the RRC connection is established between the UE 104 and the anchor carrier and that may be used to provide additional radio resources. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164. In an aspect, the UE 164 may include a positioning component 166 that may enable the UE 164 to perform the UE operations described herein. Note that although only one UE in FIG. 1 is illustrated as having fully staggered SRS component 166, any of the UEs in FIG. 1 may be configured to perform the UE operations described herein.

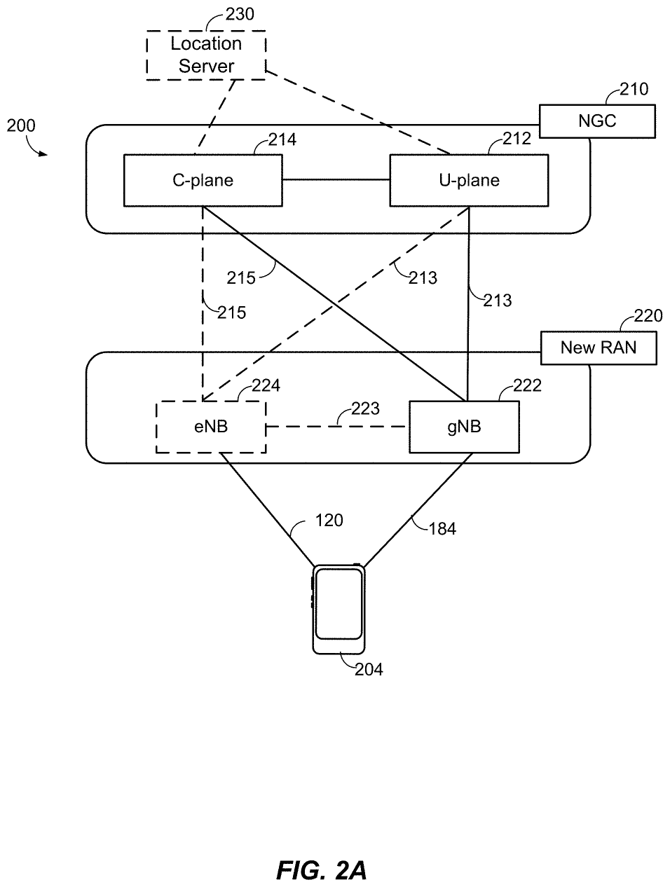

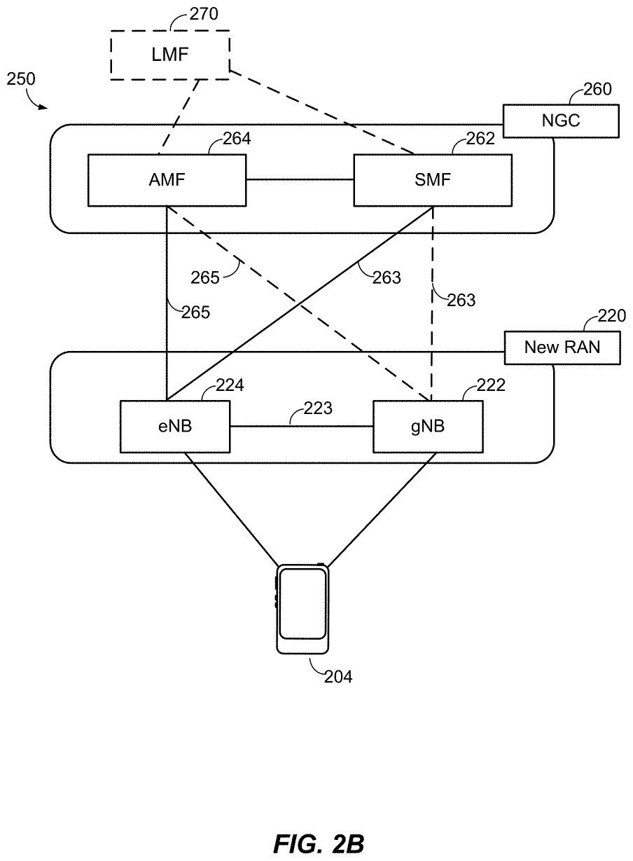

According to various aspects, FIG. 2A illustrates an example wireless network structure 200. For example, an NGC 210 (also referred to as a “5GC”) can be viewed functionally as control plane functions 214 (e.g., UE registration, authentication, network access, gateway selection, etc.) and user plane functions 212, (e.g., UE gateway function, access to data networks, IP routing, etc.) which operate cooperatively to form the core network. User plane interface (NG-U) 213 and control plane interface (NG-C) 215 connect the gNB 222 to the NGC 210 and specifically to the control plane functions 214 and user plane functions 212. In an additional configuration, an eNB 224 may also be connected to the NGC 210 via NG-C 215 to the control plane functions 214 and NG-U 213 to user plane functions 212. Further, eNB 224 may directly communicate with gNB 222 via a backhaul connection 223. In some configurations, the New RAN 220 may only have one or more gNB s 222, while other configurations include one or more of both eNBs 224 and gNBs 222. Either gNB 222 or eNB 224 may communicate with UEs 204 (e.g., any of the UEs depicted in FIG. 1). Another optional aspect may include location server 230, which may be in communication with the NGC 210 to provide location assistance for UEs 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, NGC 210, and/or via the Internet (not illustrated). Further, the location server 230 may be integrated into a component of the core network, or alternatively may be external to the core network.

According to various aspects, FIG. 2B illustrates another example wireless network structure 250. For example, an NGC 260 (also referred to as a “5GC”) can be viewed functionally as control plane functions, provided by an access and mobility management function (AMF)/user plane function (UPF) 264, and user plane functions, provided by a session management function (SMF) 262, which operate cooperatively to form the core network (i.e., NGC 260). User plane interface 263 and control plane interface 265 connect the eNB 224 to the NGC 260 and specifically to SMF 262 and AMF/UPF 264, respectively. In an additional configuration, a gNB 222 may also be connected to the NGC 260 via control plane interface 265 to AMF/UPF 264 and user plane interface 263 to SMF 262. Further, eNB 224 may directly communicate with gNB 222 via the backhaul connection 223, with or without gNB direct connectivity to the NGC 260. In some configurations, the New RAN 220 may only have one or more gNBs 222, while other configurations include one or more of both eNBs 224 and gNBs 222. Either gNB 222 or eNB 224 may communicate with UEs 204 (e.g., any of the UEs depicted in FIG. 1). The base stations of the New RAN 220 communicate with the AMF-side of the AMF/UPF 264 over the N2 interface and the UPF-side of the AMF/UPF 264 over the N3 interface.

The functions of the AMF include registration management, connection management, reachability management, mobility management, lawful interception, transport for session management (SM) messages between the UE 204 and the SMF 262, transparent proxy services for routing SM messages, access authentication and access authorization, transport for short message service (SMS) messages between the UE 204 and the short message service function (SMSF) (not shown), and security anchor functionality (SEAF). The AMF also interacts with the authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF retrieves the security material from the AUSF. The functions of the AMF also include security context management (SCM). The SCM receives a key from the SEAF that it uses to derive access-network specific keys. The functionality of the AMF also includes location services management for regulatory services, transport for location services messages between the UE 204 and the location management function (LMF) 270, as well as between the New RAN 220 and the LMF 270, evolved packet system (EPS) bearer identifier allocation for interworking with the EPS, and UE 204 mobility event notification. In addition, the AMF also supports functionalities for non-3GPP access networks.

Functions of the UPF include acting as an anchor point for intra-/inter-RAT mobility (when applicable), acting as an external protocol data unit (PDU) session point of interconnect to the data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., UL/DL rate enforcement, reflective QoS marking in the DL), UL traffic verification (service data flow (SDF) to QoS flow mapping), transport level packet marking in the UL and DL, DL packet buffering and DL data notification triggering, and sending and forwarding of one or more “end markers” to the source RAN node.

The functions of the SMF 262 include session management, UE Internet protocol (IP) address allocation and management, selection and control of user plane functions, configuration of traffic steering at the UPF to route traffic to the proper destination, control of part of policy enforcement and QoS, and downlink data notification. The interface over which the SMF 262 communicates with the AMF-side of the AMF/UPF 264 is referred to as the N11 interface.

Another optional aspect may include a LMF 270, which may be in communication with the NGC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, NGC 260, and/or via the Internet (not illustrated).

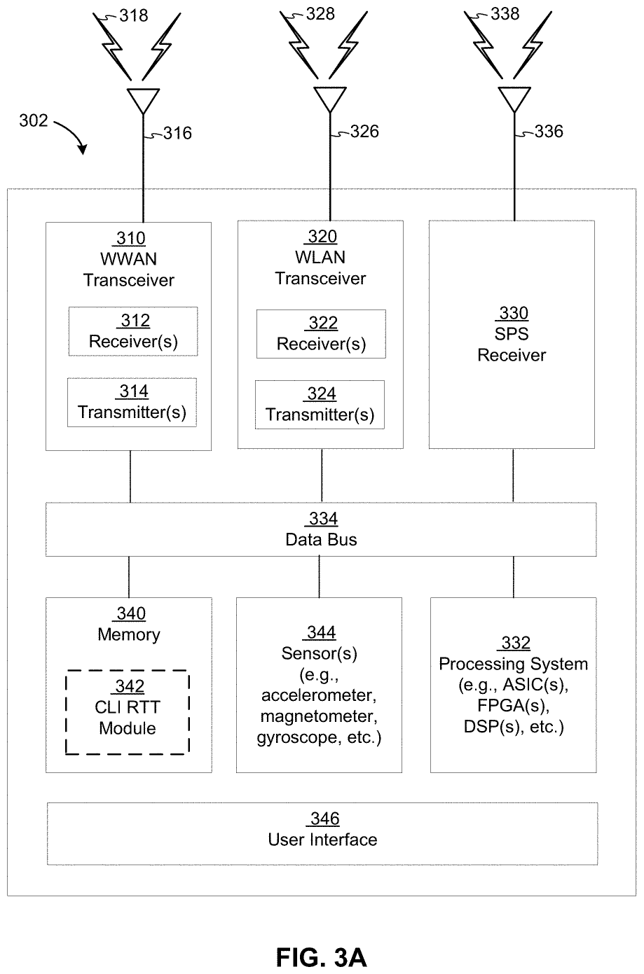

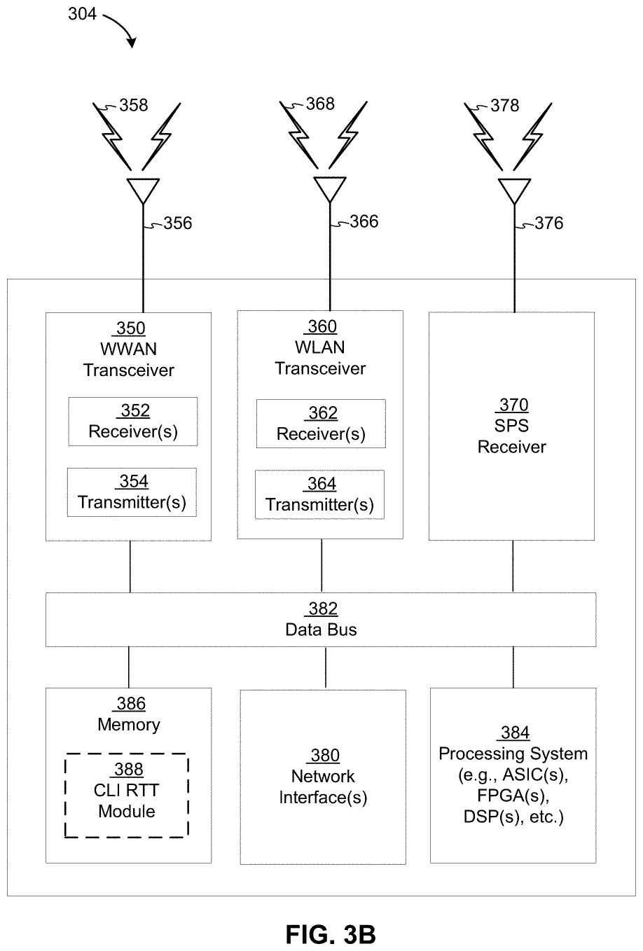

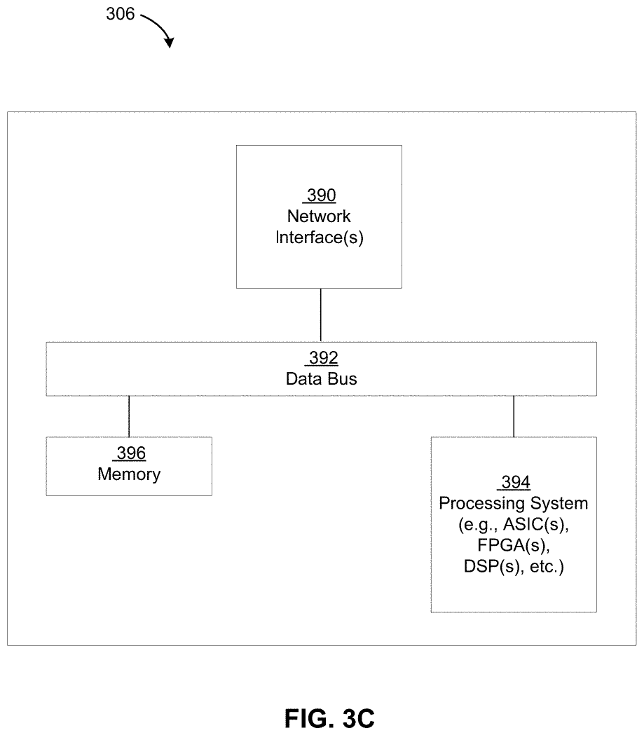

FIGS. 3A, 3B, and 3C illustrate several sample components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include wireless wide area network (WWAN) transceiver 310 and 350, respectively, configured to communicate via one or more wireless communication networks (not shown), such as an NR network, an LTE network, a GSM network, and/or the like. The WWAN transceivers 310 and 350 may be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 also include, at least in some cases, wireless local area network (WLAN) transceivers 320 and 360, respectively. The WLAN transceivers 320 and 360 may be connected to one or more antennas 326 and 366, respectively, for communicating with other network nodes, such as other UEs, access points, base stations, etc., via at least one designated RAT (e.g., WiFi, LTE-D, Bluetooth®, etc.) over a wireless communication medium of interest. The WLAN transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively.

Transceiver circuitry including a transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In an aspect, a transmitter may include or be coupled to a plurality of antennas (e.g., antennas 316, 336, and 376), such as an antenna array, that permits the respective apparatus to perform transmit “beamforming,” as described herein. Similarly, a receiver may include or be coupled to a plurality of antennas (e.g., antennas 316, 336, and 376), such as an antenna array, that permits the respective apparatus to perform receive beamforming, as described herein. In an aspect, the transmitter and receiver may share the same plurality of antennas (e.g., antennas 316, 336, and 376), such that the respective apparatus can only receive or transmit at a given time, not both at the same time. A wireless communication device (e.g., one or both of the transceivers 310 and 320 and/or 350 and 360) of the apparatuses 302 and/or 304 may also comprise a network listen module (NLM) or the like for performing various measurements.

The apparatuses 302 and 304 also include, at least in some cases, satellite positioning systems (SPS) receivers 330 and 370. The SPS receivers 330 and 370 may be connected to one or more antennas 336 and 376, respectively, for receiving SPS signals 338 and 378, respectively, such as global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. The SPS receivers 330 and 370 may comprise any suitable hardware and/or software for receiving and processing SPS signals 338 and 378, respectively. The SPS receivers 330 and 370 request information and operations as appropriate from the other systems, and performs calculations necessary to determine the apparatus' 302 and 304 positions using measurements obtained by any suitable SPS algorithm.

The base station 304 and the network entity 306 each include at least one network interfaces 380 and 390 for communicating with other network entities. For example, the network interfaces 380 and 390 (e.g., one or more network access ports) may be configured to communicate with one or more network entities via a wire-based or wireless backhaul connection. In some aspects, the network interfaces 380 and 390 may be implemented as transceivers configured to support wire-based or wireless signal communication. This communication may involve, for example, sending and receiving: messages, parameters, or other types of information.

The apparatuses 302, 304, and 306 also include other components that may be used in conjunction with the operations as disclosed herein. The UE 302 includes processor circuitry implementing a processing system 332 for providing functionality relating to, for example, false base station (FBS) detection as disclosed herein and for providing other processing functionality. The base station 304 includes a processing system 384 for providing functionality relating to, for example, FBS detection as disclosed herein and for providing other processing functionality. The network entity 306 includes a processing system 394 for providing functionality relating to, for example, FBS detection as disclosed herein and for providing other processing functionality. In an aspect, the processing systems 332, 384, and 394 may include, for example, one or more general purpose processors, multi-core processors, ASICs, digital signal processors (DSPs), field programmable gate arrays (FPGA), or other programmable logic devices or processing circuitry.

The apparatuses 302, 304, and 306 include memory circuitry implementing memory components 340, 386, and 396 (e.g., each including a memory device), respectively, for maintaining information (e.g., information indicative of reserved resources, thresholds, parameters, and so on). In some cases, the apparatuses 302 and 304 may include a cross-link interference (CLI) round-trip time (RTT) modules 342 and 388, respectively. The CLI RTT modules 342 and 388 may be hardware circuits that are part of or coupled to the processing systems 332 and 384, that, when executed, cause the apparatus 302 to perform the functionality described herein. Alternatively, the CLI RTT modules 342 and 388 may be memory modules (as shown in FIGS. 3A-3B) stored in the memory components 340 and 386, that, when executed by the processing system 332 and 384, cause the apparatus 302 and 304 to perform the functionality described herein.

The UE 302 may include one or more sensors 344 coupled to the processing system 332 to provide movement and/or orientation information that is independent of motion data derived from signals received by the WWAN transceiver 310, the WLAN transceiver 320, and/or the GPS receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in 2D and/or 3D coordinate systems.

In addition, the UE 302 includes a user interface 346 for providing indications (e.g., audible and/or visual indications) to a user and/or for receiving user input (e.g., upon user actuation of a sensing device such a keypad, a touch screen, a microphone, and so on). Although not shown, the apparatuses 304 and 306 may also include user interfaces.

Referring to the processing system 384 in more detail, in the downlink, IP packets from the network entity 306 may be provided to the processing system 384. The processing system 384 may implement functionality for an RRC layer, a packet data convergence protocol (PDCP) layer, a radio link control (RLC) layer, and a medium access control (MAC) layer. The processing system 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the processing system 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the processing system 332, which implements Layer-3 and Layer-2 functionality.

In the UL, the processing system 332 provides demultiplexing between transport and logical channels, packet reassembly, deciphering, header decompression, and control signal processing to recover IP packets from the core network. The processing system 332 is also responsible for error detection.

Similar to the functionality described in connection with the DL transmission by the base station 304, the processing system 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The UL transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the processing system 384.

In the UL, the processing system 384 provides demultiplexing between transport and logical channels, packet reassembly, deciphering, header decompression, control signal processing to recover IP packets from the UE 302. IP packets from the processing system 384 may be provided to the core network. The processing system 384 is also responsible for error detection.

For convenience, the apparatuses 302, 304, and/or 306 are shown in FIGS. 3A-C as including various components that may be configured according to the various examples described herein. It will be appreciated, however, that the illustrated blocks may have different functionality in different designs.

The various components of the apparatuses 302, 304, and 306 may communicate with each other over data buses 334, 382, and 392, respectively. The components of FIGS. 3A-C may be implemented in various ways. In some implementations, the components of FIGS. 3A-C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 396 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a positioning entity,” etc. However, as will be appreciated, such operations, acts, and/or functions may actually be performed by specific components or combinations of components of the UE, base station, positioning entity, etc., such as the processing systems 332, 384, 394, the transceivers 310, 320, 350, and 360, the memory components 340, 386, and 396, the CLI RTT modules 342, 388, etc.

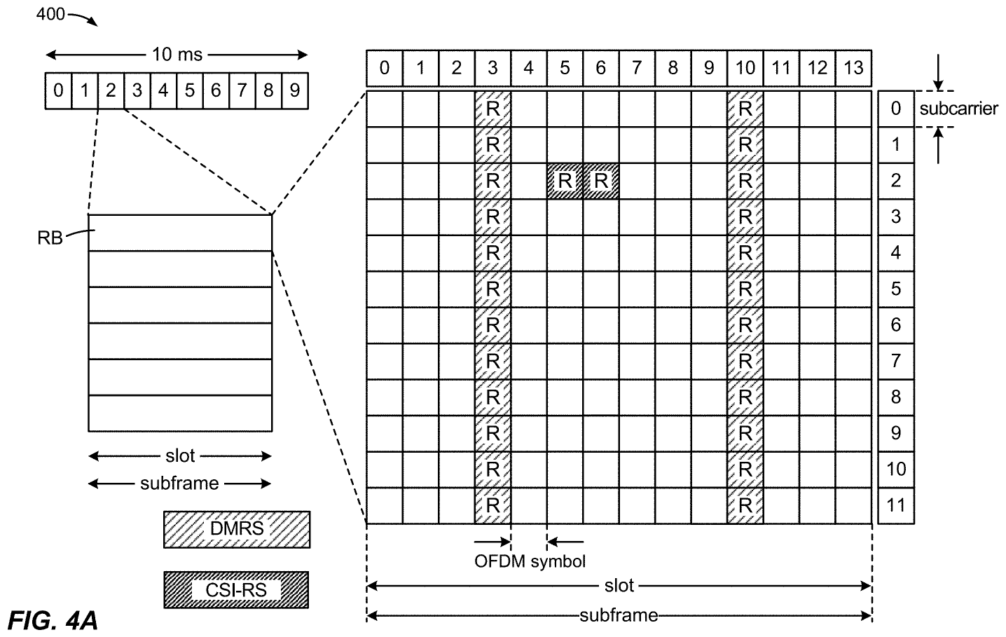

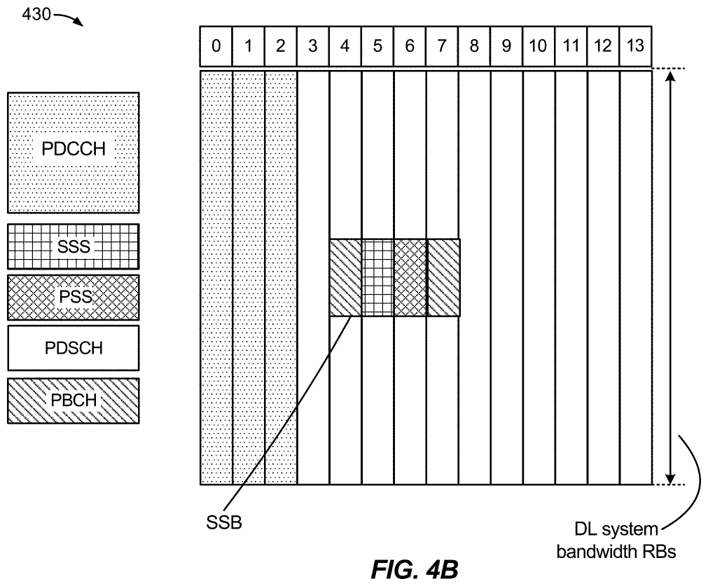

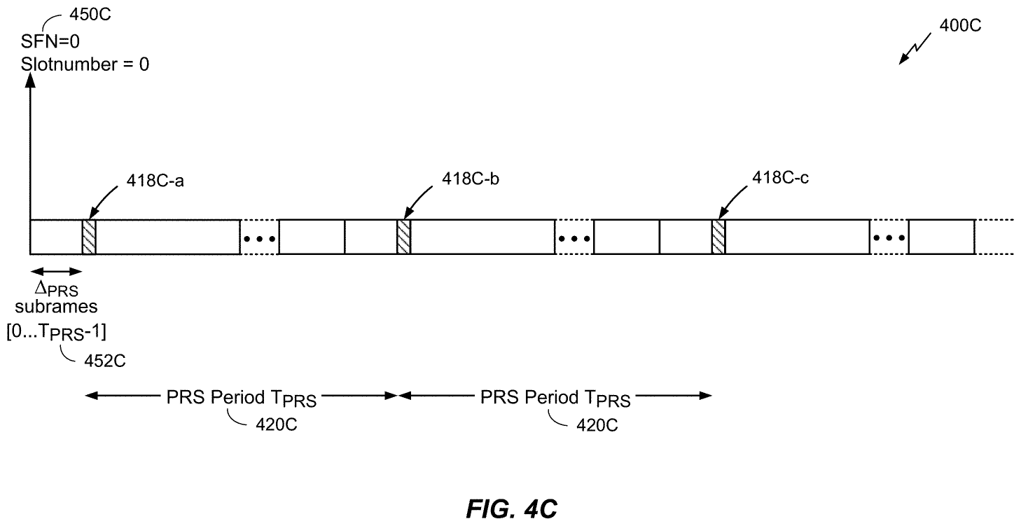

FIG. 4A is a diagram 400 illustrating an example of a DL frame structure, according to aspects of the disclosure. FIG. 4B is a diagram 430 illustrating an example of channels within the DL frame structure, according to aspects of the disclosure. Other wireless communications technologies may have a different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast NR may support multiple numerologies, for example, subcarrier spacing of 15 kHz, 30 kHz, 60 kHz, 120 kHz and 204 kHz or greater may be available. Table 1 provided below lists some various parameters for different NR numerologies.

TABLE 1

| | | | | | | Max. nominal |
|---|---|---|---|---|---|---|
| Subcarrier | Sym- | slots/ | | | Symbol | system BW |
| spacing | bols/ | sub- | slots/ | slot | duration | (MHz) with |
| (kHz) | slot | frame | frame | (ms) | (μs) | 4K FFT size |
| 15 | 14 | 1 | 10 | 1 | 66.7 | 50 |
| 30 | 14 | 2 | 20 | 0.5 | 33.3 | 100 |
| 60 | 14 | 4 | 40 | 0.25 | 16.7 | 100 |
| 120 | 14 | 8 | 80 | 0.125 | 8.33 | 400 |
| 240 | 14 | 16 | 160 | 0.0625 | 4.17 | 800 |

In the examples of FIGS. 4A and 4B, a numerology of 15 kHz is used. Thus, in the time domain, a frame (e.g., 10 ms) is divided into 10 equally sized subframes of 1 ms each, and each subframe includes one time slot. In FIGS. 4A and 4B, time is represented horizontally (e.g., on the X axis) with time increasing from left to right, while frequency is represented vertically (e.g., on the Y axis) with frequency increasing (or decreasing) from bottom to top.

A resource grid may be used to represent time slots, each time slot including one or more time concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIGS. 4A and 4B, for a normal cyclic prefix, an RB may contain 12 consecutive subcarriers in the frequency domain and 7 consecutive symbols (for DL, OFDM symbols; for UL, SC-FDMA symbols) in the time domain, for a total of 84 REs. For an extended cyclic prefix, an RB may contain 12 consecutive subcarriers in the frequency domain and 6 consecutive symbols in the time domain, for a total of 72 REs. The number of bits carried by each RE depends on the modulation scheme.

As illustrated in FIG. 4A, some of the REs carry DL reference (pilot) signals (DL-RS) for channel estimation at the UE. The DL-RS may include demodulation reference signals (DMRS) and channel state information reference signals (CSI-RS), exemplary locations of which are labeled “R” in FIG. 4A.

FIG. 4B illustrates an example of various channels within a DL subframe of a frame. The physical downlink control channel (PDCCH) carries DL control information (DCI) within one or more control channel elements (CCEs), each CCE including nine RE groups (REGs), each REG including four consecutive REs in an OFDM symbol. The DCI carries information about UL resource allocation (persistent and non-persistent) and descriptions about DL data transmitted to the UE. Multiple (e.g., up to 8) DCIs can be configured in the PDCCH, and these DCIs can have one of multiple formats. For example, there are different DCI formats for UL scheduling, for non-MIMO DL scheduling, for MIMO DL scheduling, and for UL power control.

A primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries an MIB, may be logically grouped with the PSS and SSS to form an SSB (also referred to as an SS/PBCH). The MIB provides a number of RBs in the DL system bandwidth and a system frame number (SFN). The physical downlink shared channel (PDSCH) carries user data, broadcast system information not transmitted through the PBCH such as system information blocks (SIBs), and paging messages.

In some cases, the DL RS illustrated in FIG. 4A may be a downlink (DL) positioning reference signals (PRS). FIG. 4C illustrates an exemplary DL PRS configuration 400C for a cell supported by a wireless node (such as a base station 102). FIG. 4C shows how DL PRS positioning occasions are determined by a system frame number (SFN), a cell specific subframe offset (Δ_{PRS}) 452C, and the DL PRS periodicity (T_{PRS}) 420C. Typically, the cell specific DL PRS subframe configuration is defined by a “PRS Configuration Index” I_{PRS} included in observed time difference of arrival (OTDOA) assistance data. The DL PRS periodicity (T_{PRS}) 420C and the cell specific subframe offset (Δ_{PRS}) are defined based on the DL PRS configuration index I_{PRS}, as illustrated in Table 2 below.

TABLE 2
DL PRS Configurations

| PRS configuration | PRS periodicity | PRS subframe offset |
|---|---|---|
| Index I_{PRS} | T_{PRS} (subframes) | Δ_{PRS} (subframes) |
| 0-159 | 160 | I_{PRS} |
| 160-479 | 320 | I_{PRS} − 160 |
| 480-1119 | 640 | I_{PRS} − 480 |
| 1120-2399 | 1280 | I_{PRS} − 1120 |
| 2400-2404 | 5 | I_{PRS} − 2400 |
| 2405-2414 | 10 | I_{PRS} − 2405 |
| 2415-2434 | 20 | I_{PRS} − 2415 |
| 2435-2474 | 40 | I_{PRS} − 2435 |
| 2475-2554 | 80 | I_{PRS} − 2475 |

| | |
|---|---|
| 2555-4095 | Reserved |

A DL PRS configuration is defined with reference to the SFN of a cell that transmits DL PRS. DL PRS instances, for the first subframe of the N_{PRS} downlink subframes comprising a first DL PRS positioning occasion, may satisfy:

(10×n_{f}+└nₛ/2┘−Δ_{PRS})mod T_{PRS}=0,

where n_{f} is the SFN with 0≤n_{f}≤1023, nₛ is the slot number within the radio frame defined by n_{f} with 0≤nₛ≤19, T_{PRS} is the DL PRS periodicity 420C, and APRs is the cell-specific subframe offset 452C.

As shown in FIG. 4C, the cell specific subframe offset Δ_{PRS} 452C may be defined in terms of the number of subframes transmitted starting from system frame number 0 (Slot ‘Number 0’, marked as slot 450C) to the start of the first (subsequent) DL PRS positioning occasion. In the example in FIG. 4C, the number of consecutive positioning subframes (N_{PRS}) in each of the consecutive DL PRS positioning occasions 418C-a, 418C-b, and 418C-c equals 4. That is, each shaded block representing DL PRS positioning occasions 418C-a, 418C-b, and 418C-c represents four subframes.

In some aspects, when a UE receives a PRS configuration index I_{PRS} in the OTDOA assistance data for a particular cell, the UE may determine the DL PRS periodicity T_{PRS} 420C and DL PRS subframe offset Δ_{PRS} using Table 2. The UE may then determine the radio frame, subframe, and slot when a DL PRS is scheduled in the cell (e.g., using equation (1)). The OTDOA assistance data may be determined by, for example, the location server (e.g., location server 230, LMF 270), and includes assistance data for a reference cell, and a number of neighbor cells supported by various base stations.

Typically, DL PRS occasions from all cells in a network that use the same frequency are aligned in time and may have a fixed known time offset (e.g., cell-specific subframe offset 452C) relative to other cells in the network that use a different frequency. In SFN-synchronous networks, all wireless nodes (e.g., base stations 102) may be aligned on both frame boundary and system frame number. Therefore, in SFN-synchronous networks, all cells supported by the various wireless nodes may use the same PRS configuration index for any particular frequency of DL PRS transmission. On the other hand, in SFN-asynchronous networks, the various wireless nodes may be aligned on a frame boundary, but not system frame number. Thus, in SFN-asynchronous networks the PRS configuration index for each cell may be configured separately by the network so that DL PRS occasions align in time.

A UE may determine the timing of the DL PRS occasions of the reference and neighbor cells for OTDOA positioning, if the UE can obtain the cell timing (e.g., SFN) of at least one of the cells, e.g., the reference cell or a serving cell. The timing of the other cells may then be derived by the UE based, for example, on the assumption that DL PRS occasions from different cells overlap.

A collection of resource elements that are used for transmission of DL PRS is referred to as a “PRS resource.” The collection of resource elements can span multiple PRBs in the frequency domain and N (e.g., 1 or more) consecutive symbol(s) within a slot in the time domain. In a given OFDM symbol, a DL PRS resource occupies consecutive PRBs. A DL PRS resource is described by at least the following parameters: DL PRS resource identifier (ID), sequence ID, comb size-N, resource element offset in the frequency domain, starting slot and starting symbol, number of symbols per DL PRS resource (i.e., the duration of the DL PRS resource), and QCL information (e.g., QCL with other DL reference signals). In some designs, one antenna port is supported. The comb size indicates the number of subcarriers in each symbol carrying DL PRS. For example, a comb-size of comb-4 means that every fourth subcarrier of a given symbol carries DL PRS.

A “PRS resource set” is a set of DL PRS resources used for the transmission of DL PRS signals, where each DL PRS resource has a PRS resource ID. In addition, the DL PRS resources in a DL PRS resource set are associated with the same transmission-reception point (TRP). A PRS resource ID in a PRS resource set is associated with a single beam transmitted from a single TRP (where a TRP may transmit one or more beams). That is, each DL PRS resource of a DL PRS resource set may be transmitted on a different beam, and as such, a “PRS resource” can also be referred to as a “beam.” Note that this does not have any implications on whether the TRPs and the beams on which DL PRS are transmitted are known to the UE. A “DL PRS occasion” is one instance of a periodically repeated time window (e.g., a group of one or more consecutive slots) where DL PRS are expected to be transmitted. A DL PRS occasion may also be referred to as a “DL PRS positioning occasion,” a “positioning occasion,” or simply an “occasion.”

Note that the terms “positioning reference signal” and “PRS” may sometimes refer to specific reference signals that are used for positioning in LTE or NR systems. However, as used herein, unless otherwise indicated, the terms “positioning reference signal” and “PRS” refer to any type of reference signal that can be used for positioning, such as but not limited to, PRS signals in LTE or NR, navigation reference signals (NRS s) in 5G, transmitter reference signals (TRSs), cell-specific reference signals (CRSs), channel state information reference signals (CSI-RSs), primary synchronization signals (PSSs), secondary synchronization signals (SSSs), SSB, etc.

Uplink (UL) reference signals may also be configured as PRS. For example, SRS is an uplink-only signal that a UE transmits to help the base station obtain the channel state information (CSI) for each user. Channel state information describes how an RF signal propagates from the UE to the base station and represents the combined effect of scattering, fading, and power decay with distance. The system uses the SRS for resource scheduling, link adaptation, massive MIMO, beam management, etc.

Several enhancements over the previous definition of SRS have been proposed for SRS for positioning (SRS-P) (e.g., as used herein, SRS-P is one example of a UL PRS), such as a new staggered pattern within an SRS resource, a new comb type for SRS, new sequences for SRS, a higher number of SRS resource sets per component carrier, and a higher number of SRS resources per component carrier. In addition, the parameters “SpatialRelationInfo” and “PathLossReference” are to be configured based on a DL RS from a neighboring TRP. Further still, one SRS resource may be transmitted outside the active bandwidth part (BWP), and one SRS resource may span across multiple component carriers. Lastly, the UE may transmit through the same transmit beam from multiple SRS resources for UL-AoA. All of these are features that are additional to the current SRS framework, which is configured through RRC higher layer signaling (and potentially triggered or activated through MAC control element (CE) or downlink control information (DCI)).

As noted above, SRSs in NR are UE-specifically configured reference signals transmitted by the UE used for the purposes of the sounding the uplink radio channel. Similar to CSI-RS, such sounding provides various levels of knowledge of the radio channel characteristics. On one extreme, the SRS can be used at the gNB simply to obtain signal strength measurements, e.g., for the purposes of UL beam management. On the other extreme, SRS can be used at the gNB to obtain detailed amplitude and phase estimates as a function of frequency, time and space. In NR, channel sounding with SRS supports a more diverse set of use cases compared to LTE (e.g., downlink CSI acquisition for reciprocity-based gNB transmit beamforming (downlink MIMO); uplink CSI acquisition for link adaptation and codebook/non-codebook based precoding for uplink MIMO, uplink beam management, etc.).

The SRS can be configured using various options. The time/frequency mapping of an SRS resource is defined by the following characteristics.
Time duration N_{symb}^{SRS}—The time duration of an SRS resource can be 1, 2, or 4 consecutive OFDM symbols within a slot, in contrast to LTE which allows only a single OFDM symbol per slot.
Starting symbol location l₀—The starting symbol of an SRS resource can be located anywhere within the last 6 OFDM symbols of a slot provided the resource does not cross the end-of-slot boundary.
Repetition factor R—For an SRS resource configured with frequency hopping, repetition allows the same set of subcarriers to be sounded in R consecutive OFDM symbols before the next hop occurs (as used herein, a “hop” refers to specifically to a frequency hop). For example, values of R are 1, 2, 4 where R≤N_{symb}^{SRS}.
Transmission comb spacing K_{TC} and comb offset k_{TC}—An SRS resource may occupy resource elements (REs) of a frequency domain comb structure, where the comb spacing is either 2 or 4 REs like in LTE. Such a structure allows frequency domain multiplexing of different SRS resources of the same or different users on different combs, where the different combs are offset from each other by an integer number of REs. The comb offset is defined with respect to a PRB boundary, and can take values in the range 0, 1, . . . , K_{TC}−1 REs. Thus, for comb spacing K_{TC}=2, there are 2 different combs available for multiplexing if needed, and for comb spacing K_{TC}=4, there are 4 different available combs.
Periodicity and slot offset for the case of periodic/semi-persistent SRS.
Sounding bandwidth within a bandwidth part.

For low latency positioning, a gNB may trigger a PRS (e.g., UL PRS such as UL SRS-P, DL PRS, RTT procedure comprising both UL PRS and DL PRS with Rx-Tx time difference measurement, etc.) via a DCI (e.g., transmitted SRS-P may include repetition or beam-sweeping to enable several gNBs to receive the SRS-P). Alternatively, the gNB may send information regarding aperiodic PRS (e.g., UL PRS or DL PRS) transmission to the UE (e.g., this configuration may include information about PRS from multiple gNBs to enable the UE to perform timing computations for positioning (UE-based) or for reporting (UE-assisted). While various embodiments of the present disclosure relate to DL PRS-based positioning procedures, some or all of such embodiments may also apply to UL SRS-P-based (or more generally, UL PRS-based) positioning procedures.

Note that the terms “sounding reference signal”, “SRS” and “SRS-P” may sometimes refer to specific reference signals that are used for positioning in LTE or NR systems. However, as used herein, unless otherwise indicated, the terms “sounding reference signal”, “SRS” and “SRS-P” refer to any type of reference signal that can be used for positioning, such as but not limited to, SRS signals in LTE or NR, navigation reference signals (NRSs) in 5G, transmitter reference signals (TRSs), random access channel (RACH) signals for positioning (e.g., RACH preambles, such as Msg-1 in 4-Step RACH procedure or Msg-A in 2-Step RACH procedure), etc.

3GPP Rel. 16 introduced various NR positioning aspects directed to increase location accuracy of positioning schemes that involve measurement(s) associated with one or more UL or DL PRSs (e.g., higher bandwidth (BW), FR2 beam-sweeping, angle-based measurements such as Angle of Arrival (AoA) and Angle of Departure (AoD) measurements, multi-cell Round-Trip Time (RTT) measurements, etc.). If latency reduction is a priority, then UE-based positioning techniques (e.g., DL-only techniques without UL location measurement reporting) are typically used. However, if latency is less of a concern, then UE-assisted positioning techniques can be used, whereby UE-measured data is reported to a network entity (e.g., location server 230, LMF 270, etc.). Latency associated UE-assisted positioning techniques can be reduced somewhat by implementing the LMF in the RAN.

Layer-3 (L3) signaling (e.g., RRC or Location Positioning Protocol (LPP)) is typically used to transport reports that comprise location-based data in association with UE-assisted positioning techniques. L3 signaling is associated with relatively high latency (e.g., above 100 ms) compared with Layer-1 (L1, or PHY layer) signaling or Layer-2 (L2, or MAC layer) signaling. In some cases, lower latency (e.g., less than 100 ms, less than 10 ms, etc.) between the UE and the RAN for location-based reporting may be desired. In such cases, L3 signaling may not be capable of reaching these lower latency levels. L3 signaling of positioning measurements may comprise any combination of the following:
One or multiple TOA, TDOA, RSRP or Rx-Tx time difference measurements,
One or multiple AoA/AoD (e.g., currently agreed only for gNB->LMF reporting DL AoA and UL AoD) measurements,
One or multiple Multipath reporting measurements, e.g., per-path ToA, RSRP, AoA/AoD (e.g., currently only per-path ToA allowed in LTE)
One or multiple motion states (e.g., walking, driving, etc.) and trajectories (e.g., currently for UE), and/or
One or multiple report quality indications.

More recently, L1 and L2 signaling has been contemplated for use in association with DL PRS-based reporting. For example, L1 and L2 signaling is currently used in some systems to transport CSI reports (e.g., reporting of Channel Quality Indications (CQIs), Precoding Matrix Indicators (PMIs), Layer Indicators (Lis), L1-RSRP, etc.). CSI reports may comprise a set of fields in a pre-defined order (e.g., defined by the relevant standard). A single UL transmission (e.g., on PUSCH or PUCCH) may include multiple reports, referred to herein as ‘sub-reports’, which are arranged according to a pre-defined priority (e.g., defined by the relevant standard). In some designs, the pre-defined order may be based on an associated sub-report periodicity (e.g., aperiodic/semi-persistent/periodic (A/SP/P) over PUSCH/PUCCH), measurement type (e.g., L1-RSRP or not), serving cell index (e.g., in carrier aggregation (CA) case), and reportconfigID. With 2-part CSI reporting, the part 1s of all reports are grouped together, and the part 2s are grouped separately, and each group is separately encoded (e.g., part 1 payload size is fixed based on configuration parameters, while part 2 size is variable and depends on configuration parameters and also on associated part 1 content). A number of coded bits/symbols to be output after encoding and rate-matching is computed based on a number of input bits and beta factors, per the relevant standard. Linkages (e.g., time offsets) are defined between instances of RSs being measured and corresponding reporting. In some designs, CSI-like reporting of DL PRS-based measurement data using L1 and L2 signaling may be implemented.

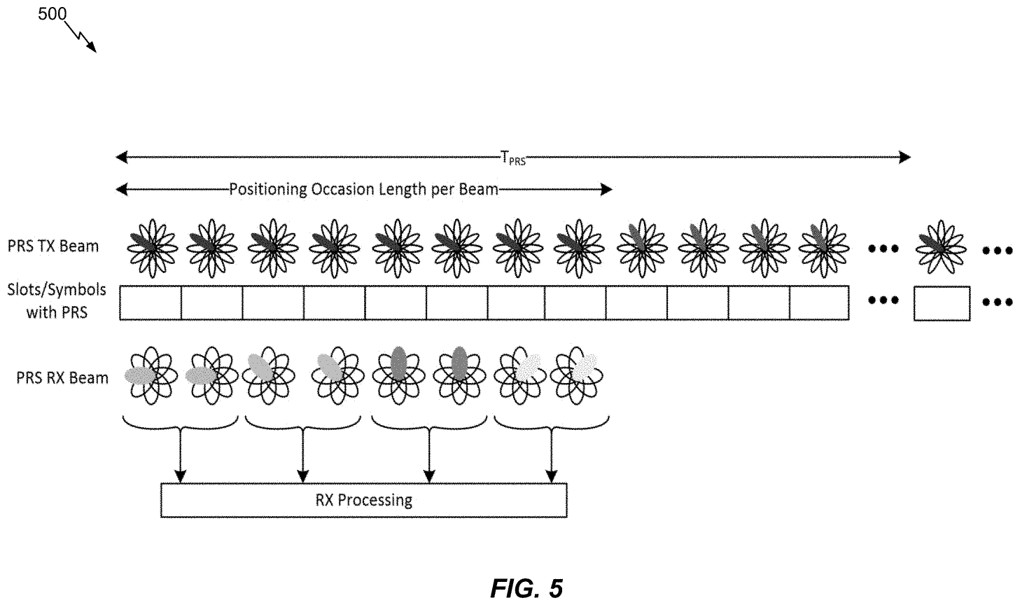

FIG. 5 illustrates exemplary DL PRSs 500 being processed through a wireless communications system according to aspects of the disclosure. In FIG. 5, a PRS transmit beams are transmitted by a cell (or transmission reception point (TRP)) over a series of beam-specific positioning occasions on respective slots/symbols during a positioning session (T_{PRS}). These PRS transmit beams are received as PRS receive beams at a UE, and then processed (e.g., various positioning measurements are made by the UE, etc.).

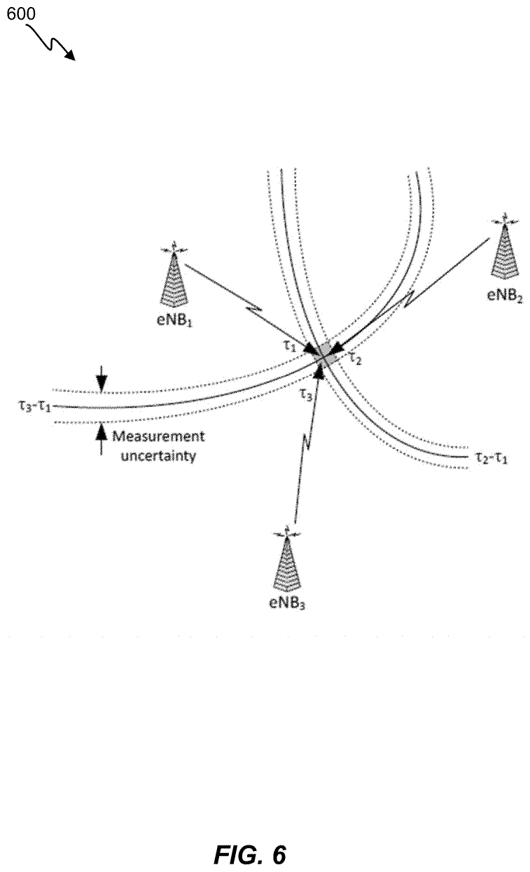

FIG. 6 illustrates an exemplary wireless communications system 600 according to aspects of the disclosure. In FIG. 6, eNB₁, eNB₂ and eNB₃ are synchronized with each other, such that TOA (e.g., TDOA) measurements (denoted as T₁, T₂ and T₃) can be used to generate a positioning estimate for a UE. Multiple TDOA measurements may be used for triangulation (e.g., 4 or more cells or eNBs). In TDOA-based positioning schemes, network synchronization error is the main bottleneck in terms of positioning accuracy.

Another positioning technique that requires cell (or satellite) synchronization is based on Observed Time Difference Of Arrival (OTDOA). One example OTDOA-based positioning scheme is GPS, which is limited to an accuracy of 50-100 ns (e.g., 15-30 meters).

In NR, there is no requirement for precise timing synchronization across the network. Instead, it is sufficient to have coarse time-synchronization across gNBs (e.g., within a cyclic prefix (CP) duration of the OFDM symbols). RTT-based methods generally only need coarse timing synchronization, and as such, are a preferred positioning method in NR.

In a network-centric RTT estimation, the serving base station (e.g., base station 102) instructs the UE (e.g., UE 104) to scan for/receive RTT measurement signals (e.g., PRS) on serving cells and two or more neighboring base stations (e.g., at least three base stations are needed). The one of more base stations transmit RTT measurement signals on low reuse resources (e.g., resources used by the base station to transmit system information) allocated by the network (e.g., location server 230, LMF 270). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS, UL-PRS) to the one or more base stations (e.g., when instructed by its serving base station) and may include the difference T_{Rx→Tx} (e.g., T_{Rx→Tx} 1012 in FIG. 10) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} (e.g., T_{Tx→Rx} 1022 in FIG. 10) between the transmission time of the RTT measurement signal and the ToA of the RTT response to the UE-reported difference T_{Rx→Tx} (e.g., T_{Rx→Tx} 1012 in FIG. 10), the base station can deduce the propagation time between the base station and the UE, from which it can then determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

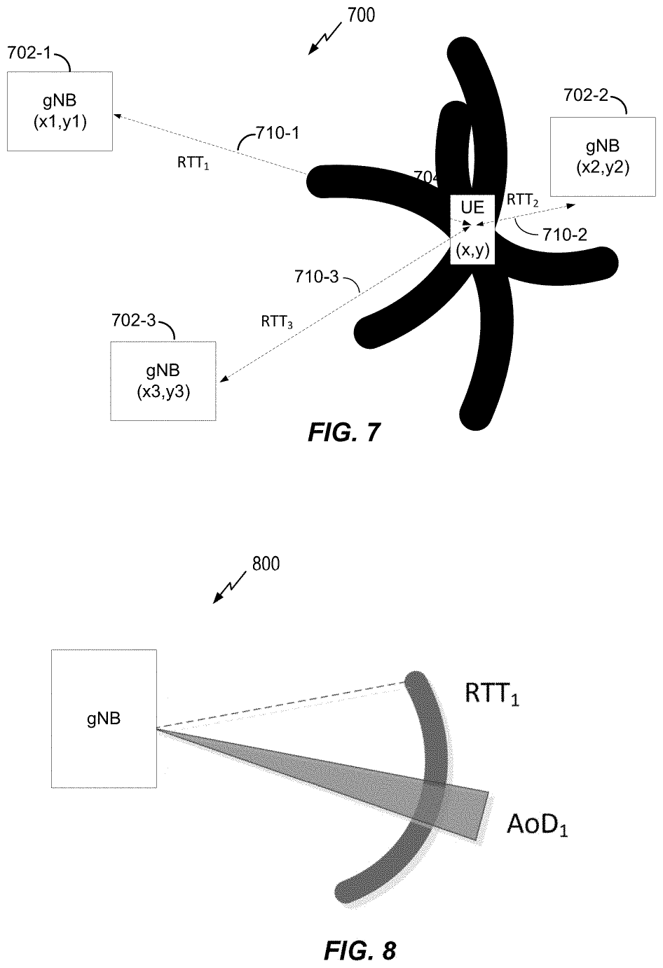

FIG. 7 illustrates an exemplary wireless communications system 700 according to aspects of the disclosure. In the example of FIG. 7, a UE 704 (which may correspond to any of the UEs described herein) is attempting to calculate an estimate of its position, or assist another entity (e.g., a base station or core network component, another UE, a location server, a third party application, etc.) to calculate an estimate of its position. The UE 704 may communicate wirelessly with a plurality of base stations 702-1, 702-2, and 702-3 (collectively, base stations 702, and which may correspond to any of the base stations described herein) using RF signals and standardized protocols for the modulation of the RF signals and the exchange of information packets. By extracting different types of information from the exchanged RF signals, and utilizing the layout of the wireless communications system 700 (i.e., the base stations' locations, geometry, etc.), the UE 704 may determine its position, or assist in the determination of its position, in a predefined reference coordinate system. In an aspect, the UE 704 may specify its position using a two-dimensional coordinate system; however, the aspects disclosed herein are not so limited, and may also be applicable to determining positions using a three-dimensional coordinate system, if the extra dimension is desired. Additionally, while FIG. 7 illustrates one UE 704 and three base stations 702, as will be appreciated, there may be more UEs 704 and more base stations 702.

To support position estimates, the base stations 702 may be configured to broadcast reference RF signals (e.g., PRS, NRS, CRS, TRS, CSI-RS, PSS, SSS, etc.) to UEs 704 in their coverage area to enable a UE 704 to measure characteristics of such reference RF signals. For example, the UE 704 may measure the ToA of specific reference RF signals (e.g., PRS, NRS, CRS, CSI-RS, etc.) transmitted by at least three different base stations 702 and may use the RTT positioning method to report these ToAs (and additional information) back to the serving base station 702 or another positioning entity (e.g., location server 230, LMF 270).

In an aspect, although described as the UE 704 measuring reference RF signals from a base station 702, the UE 704 may measure reference RF signals from one of multiple cells supported by a base station 702. Where the UE 704 measures reference RF signals transmitted by a cell supported by a base station 702, the at least two other reference RF signals measured by the UE 704 to perform the RTT procedure would be from cells supported by base stations 702 different from the first base station 702 and may have good or poor signal strength at the UE 704.

In order to determine the position (x, y) of the UE 704, the entity determining the position of the UE 704 needs to know the locations of the base stations 702, which may be represented in a reference coordinate system as (xₖ, yₖ), where k=1, 2, 3 in the example of FIG. 7. Where one of the base stations 702 (e.g., the serving base station) or the UE 704 determines the position of the UE 704, the locations of the involved base stations 702 may be provided to the serving base station 702 or the UE 704 by a location server with knowledge of the network geometry (e.g., location server 230, LMF 270). Alternatively, the location server may determine the position of the UE 704 using the known network geometry.

Either the UE 704 or the respective base station 702 may determine the distance (dₖ, where k=1, 2, 3) between the UE 704 and the respective base station 702. In an aspect, determining the RTT 710 of signals exchanged between the UE 704 and any base station 702 can be performed and converted to a distance (dₖ). As discussed further below, RTT techniques can measure the time between sending a signaling message (e.g., reference RF signals) and receiving a response. These methods may utilize calibration to remove any processing delays. In some environments, it may be assumed that the processing delays for the UE 704 and the base stations 702 are the same. However, such an assumption may not be true in practice.

Once each distance dₖ is determined, the UE 704, a base station 702, or the location server (e.g., location server 230, LMF 270) can solve for the position (x, y) of the UE 704 by using a variety of known geometric techniques, such as, for example, trilateration. From FIG. 7, it can be seen that the position of the UE 704 ideally lies at the common intersection of three semicircles, each semicircle being defined by radius dₖ and center (xₖ, yₖ), where k=1, 2, 3.

In some instances, additional information may be obtained in the form of an angle of arrival (AoA) or angle of departure (AoD) that defines a straight line direction (e.g., which may be in a horizontal plane or in three dimensions) or possibly a range of directions (e.g., for the UE 704 from the location of a base station 702). The intersection of the two directions at or near the point (x, y) can provide another estimate of the location for the UE 704.

A position estimate (e.g., for a UE 704) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

FIG. 8 illustrates an exemplary wireless communications system 800 according to aspects of the disclosure. While FIG. 7 depicts an example of a multi-cell RTT positioning scheme, FIG. 8 depicts an example of a single-cell RTT positioning scheme. In FIG. 8, RTT₁ is measured along with an AoD₁ associated with a beam on which a DL PRS is transmitted from a cell to a UE. The overlapping region of the RTT₁ and AoD₁ depicted in FIG. 8 provides a coarse location estimate for the associated UE.

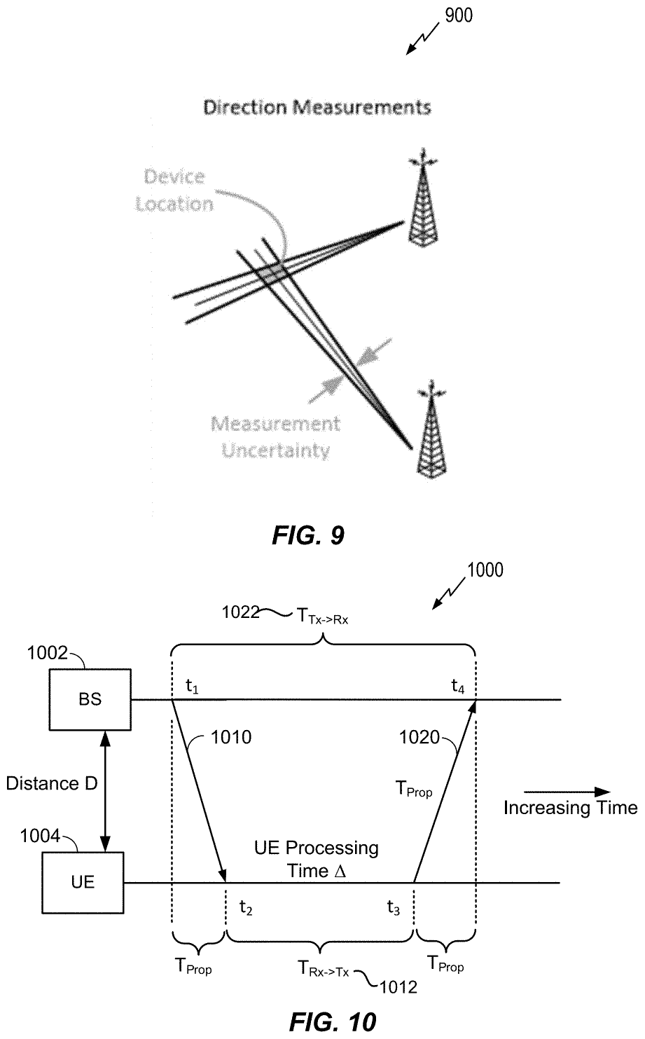

FIG. 9 illustrates is an exemplary wireless communications system 900 according to aspects of the disclosure. In particular, FIG. 10 depicts a directional positioning scheme whereby two AoA or AoD measurements are determined, whereby an overlapping region of the two AoA or AoD measurements provide a coarse location estimate for the associated UE.

FIG. 10 is a diagram 1000 showing exemplary timings of RTT measurement signals exchanged between a base station 1002 (e.g., any of the base stations described herein) and a UE 1004 (e.g., any of the UEs described herein), according to aspects of the disclosure. In the example of FIG. 10, the base station 1002 sends an RTT measurement signal 1010 (e.g., PRS, NRS, CRS, CSI-RS, etc.) to the UE 1004 at time t₁. The RTT measurement signal 1010 has some propagation delay T_{Prop} as it travels from the base station 1002 to the UE 1004. At time t₂ (the ToA of the RTT measurement signal 1010 at the UE 1004), the UE 1004 receives/measures the RTT measurement signal 1010. After some UE processing time, the UE 1004 transmits an RTT response signal 1020 at time t₃. After the propagation delay T_{Prop}, the base station 1002 receives/measures the RTT response signal 1020 from the UE 1004 at time t₄ (the ToA of the RTT response signal 1020 at the base station 1002).

In order to identify the ToA (e.g., t₂) of a reference signal (e.g., an RTT measurement signal 1010) transmitted by a given network node (e.g., base station 1002), the receiver (e.g., UE 1004) first jointly processes all the resource elements (REs) on the channel on which the transmitter is transmitting the reference signal, and performs an inverse Fourier transform to convert the received reference signals to the time domain. The conversion of the received reference signals to the time domain is referred to as estimation of the channel energy response (CER). The CER shows the peaks on the channel over time, and the earliest “significant” peak should therefore correspond to the ToA of the reference signal. Generally, the receiver will use a noise-related quality threshold to filter out spurious local peaks, thereby presumably correctly identifying significant peaks on the channel. For example, the receiver may choose a ToA estimate that is the earliest local maximum of the CER that is at least X dB higher than the median of the CER and a maximum Y dB lower than the main peak on the channel. The receiver determines the CER for each reference signal from each transmitter in order to determine the ToA of each reference signal from the different transmitters.

In some designs, the RTT response signal 1020 may explicitly include the difference between time t₃ and time t₂ (i.e., T_{Rx→Tx} 1012). Using this measurement and the difference between time t₄ and time t₁ (i.e., T_{Tx→Rx} 1022), the base station 1002 (or other positioning entity, such as location server 230, LMF 270) can calculate the distance to the UE 1004 as:

$$d = \frac{1}{2 c} ( {T}_{Tx \to Rx} - {T}_{R x \to T x} ) = \frac{1}{2 c} ( {t}_{2} - {t}_{1} ) - \frac{1}{2 c} ( {t}_{4} - {t}_{3} )$$

where c is the speed of light. While not illustrated expressly in FIG. 10, an additional source of delay or error may be due to UE and gNB hardware group delay for position location.

Cross-link interference (CLI) is UE-to-UE interference, whereby transmissions from an ‘aggressor’ UE cause interference at a ‘victim’ UE. For example, in a TDD system, nearby UEs have different UL-DL slot formats, and a victim UE may receive a transmission from an aggressor UE within a UL (transmission) symbol (i.e., interfering symbol) of the aggressor UE which collides with a DL (reception) symbol of the victim UE.

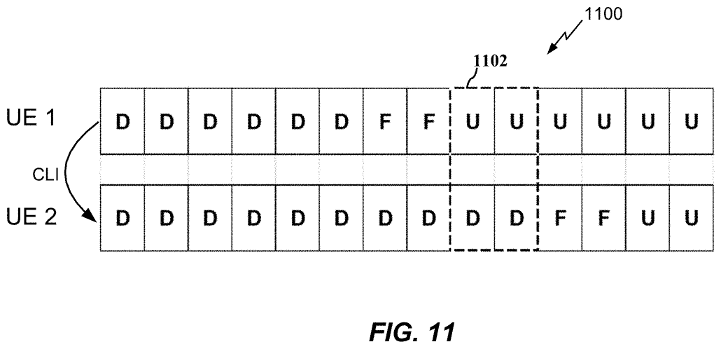

FIG. 11 illustrates a series of symbols 1100 associated with an aggressor UE 1 and a victim UE 2 in accordance with other aspects of the disclosure. The symbols comprise uplink symbols denoted as U with the respective UE is transmitting, downlink symbols denoted as D where the respective UE is receiving, and transition symbols denoted as F where the respective UE is neither receiving nor transmitting. In FIG. 11, CLI may occur at symbols 1102, where UE 1 is configured with U symbols (e.g., PUCCH, PUSCH, PRACH preamble, SRS, etc.) while UE 2 is configured with D symbols.

The network may configure CLI interference resources for interference management. In this case, a victim UE may be configured to measure CLI from an aggressor UE in the CLI interference resources. Generally, this CLE measurement procedure does not impact the UL transmission of the aggressor UE.

In 3GPP Rel. 16, Layer-3 measurement and reporting mechanisms are defined for CLI. For example, a CLI measurement may comprise SRS-RSRP or CLI Received Signal Strength Indicator (RSSI). In some designs, the CLI measurement resource configuration may be provided in measurement objects. In some designs, the may comprise periodicity, frequency RBs and OFDM symbols where CLI is to be measured.

Dynamic TDD may include DL/UL switching based on the scheduling. At some times, with the format of UE 1 UL transmission and UE 2 with DL reception, UE 1 may introduce the interference to UE 2. At other times, with another slot configuration, the UE 2 would also introduce the interference to UE 1. In such scenarios, reciprocal (two-way or bilateral) CLI may be measured.

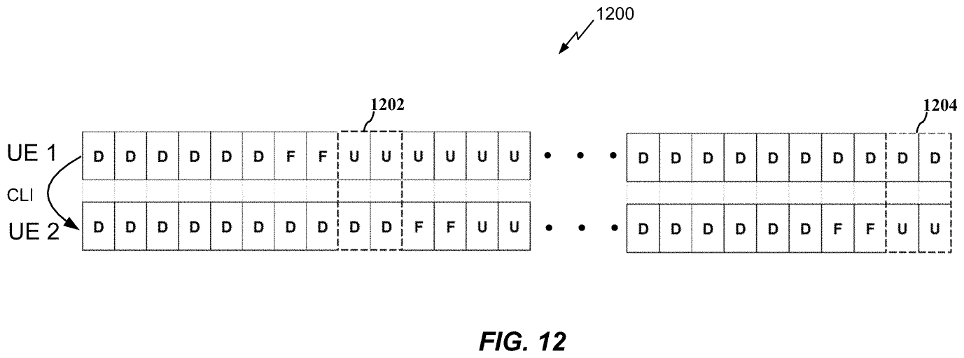

FIG. 12 illustrates a series of symbols 1200 associated with UE 1 and UE 2 in accordance with other aspects of the disclosure. CLI from UE 1 to UE 2 occurs at symbols 1202, where UE 2 is configured with U symbols (e.g., PUCCH, PUSCH, PRACH preamble, SRS, etc.) while UE 2 is configured with D symbols. CLI from UE 2 to UE 1 occurs at symbols 1204, where UE 2 is configured with U symbols (e.g., PUCCH, PUSCH, PRACH preamble, SRS, etc.) while UE 1 is configured with D symbols.

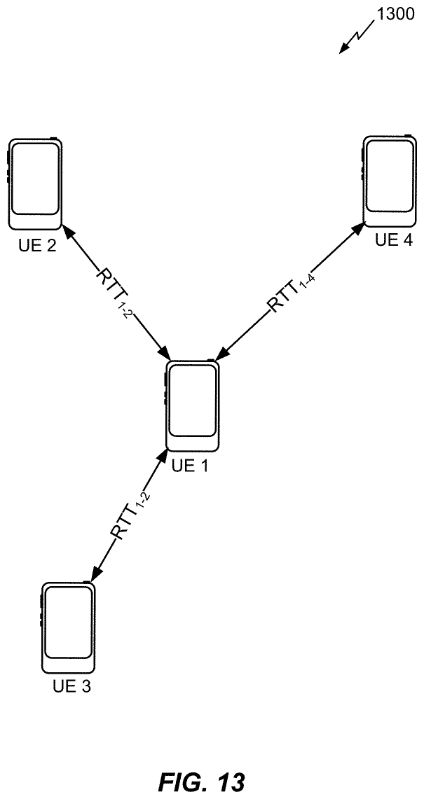

FIG. 13 illustrates a scenario 1300 where UE 1 is proximate to UEs 2-4 in accordance with an embodiment of the disclosure. The relative distances between UE 1 and each of UEs 2 . . . 4 can be estimated in a manner similar to the BS-UE RTT measurements described above, and then factored into one or more positioning measurements. Generally, such RTT measurements must be dynamically scheduled by the network, which can be somewhat burdensome.

Embodiments of the disclosure are directed to opportunistically leveraging a CLI measurement resource configuration to perform an RTT measurement between UEs. In some designs, RTT measurements may be piggybacked onto a CLI measurement procedure while the CLI measurement procedure itself remains unchanged. Such an approach may provide various technical advantages, such as simplifying the manner in which UE-to-UE RTT measurement procedures are implemented and reducing resource utilization associated with UE-to-UE RTT measurement procedures.

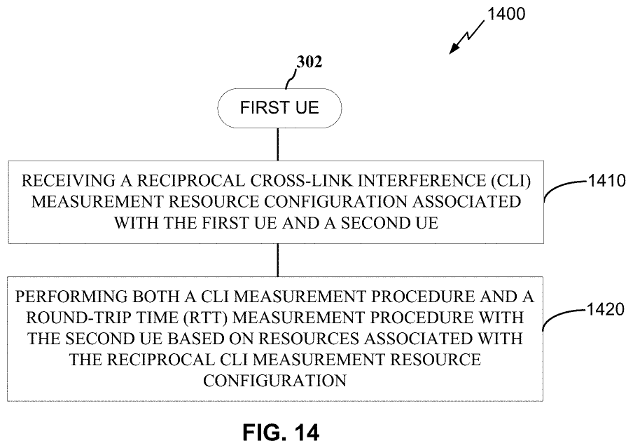

FIG. 14 illustrates an exemplary process 1400 of wireless communication, according to aspects of the disclosure. The process 1400 may be performed by a first UE, such as UE 302.

At 1410, the first UE (e.g., receiver 312, receiver 322, etc.) receives a reciprocal CLI measurement resource configuration associated with the first UE and a second UE. For example, the CLI measurement resource configuration may be received from a base station, such as BS 304. In some designs, the CLI measurement resource configuration may configure a first resource associated with a first reference signal for positioning from the first UE to the second UE and a second resource associated with a second reference signal for positioning from the second UE to the first UE. For example, the first and/or second reference signals may correspond to SRSs, SRS-Ps (e.g., ‘legacy’ positioning SRSs) or sidelink reference signals (SL-RSs).

At 1420, the first UE (e.g., receiver 312, transmitter 314, receiver 322, transmitter 324, etc.) performs both a CLI measurement procedure and an RTT measurement procedure with the second UE based on resources associated with the reciprocal CLI measurement resource configuration. As will be described below in more detail, the first UE may either be an initiator UE which transmits an initial reference signal for positioning for the RTT measurement procedure, or a responding UE which transmits a response reference signal for positioning.

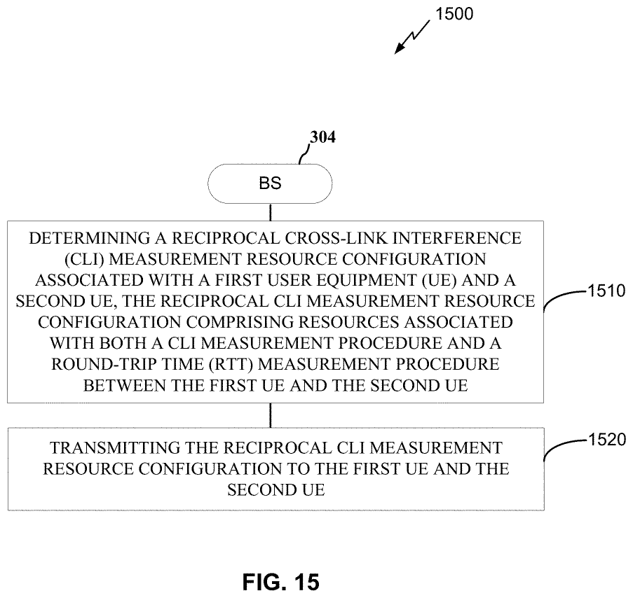

FIG. 15 illustrates an exemplary process 1500 of wireless communication, according to aspects of the disclosure. The process 1500 may be performed by a base station, such as BS 304.

At 1510, BS 304 (e.g., processing system 384, CLI RTT module 388, etc.) determines a reciprocal CLI measurement resource configuration associated with a first UE and a second UE, the reciprocal CLI measurement resource configuration comprising resources associated with both a CLI measurement procedure and a round-trip time (RTT) measurement procedure between the first UE and the second UE. In some designs, the CLI measurement resource configuration may configure a first resource associated with a first reference signal for positioning from the first UE to the second UE and a second resource associated with a second reference signal for positioning from the second UE to the first UE. For example, the first and/or second reference signals may correspond to SRSs, SRS-Ps (e.g., ‘legacy’ positioning SRSs), or SL-RSs.

At 1520, BS 304 (e.g., transmitter 354, transmitter 364, etc.) transmits the reciprocal CLI measurement resource configuration to the first UE and the second UE.

Referring to FIGS. 14-15, in some designs as noted above, the first UE may correspond to the initiator UE associated with the RTT measurement procedure. In this case, the first UE transmits, on a first resource associated with the reciprocal CLI measurement resource configuration, a first reference signal for positioning to the second UE, and measures a first time (t₁) associated with the transmission of the first reference signal for positioning. The first UE further receives, in response to the transmission of the first reference signal on a second resource associated with the reciprocal CLI measurement resource configuration, a second reference signal for positioning from the second UE, and measures a second time (t₄) associated with the reception of the second reference signal for positioning. In some designs, the first UE may report timing measurement information associated with a delay from the first measured time (t₁) to the second measured time (t₄). For example, the report can be directed to an entity that calculates the RTT, such as the second UE or a network entity (e.g., the base station, or a network entity such as LMF via the base station). In some designs, the first UE may receive, from the base station based in part on the reported timing measurement information, an indication of an RTT associated with the RTT measurement procedure. In some designs, the first UE may be the entity which calculates the RTT. In this case, the first UE may further receive, from the second UE, timing measurement information associated with a delay from a third time (t₂) at which the first reference signal for positioning is received at the second UE and a fourth time (t₃) at which the second reference signal for positioning is transmitted from the second UE. The first UE may then calculate an RTT between the first UE and the second UE based on the first time (t₁), the second time (t₄), and the timing measurement information (t₂->t₃).

Referring to FIGS. 14-15, in other designs, the first UE may correspond to the responder UE associated with the RTT measurement procedure. In this case, the first UE receives, on a first resource associated with the reciprocal CLI measurement resource configuration, a first reference signal for positioning from the second UE, and measures a first time (t₂) associated with the reception of the first reference signal for positioning. The first UE further transmits, in response to the reception of the first reference signal for positioning on a second resource associated with the reciprocal CLI measurement resource configuration, a second reference signal for positioning to the second UE, and measures a second time (t₃) associated with the transmission of the second reference signal for positioning. In some designs, the first UE may report timing measurement information associated with a delay from the first measured time (t₂) to the second measured time (t₃). For example, the report can be directed to an entity that calculates the RTT, such as the second UE or a network entity (e.g., the base station, or a network entity such as LMF via the base station). In some designs, the first UE may receive, from the base station based in part on the reported timing measurement information, an indication of an RTT associated with the RTT measurement procedure. In some designs, the first UE may be the entity which calculates the RTT (e.g., based on timing measurement information indicative of t₄->t₃ from the second UE).

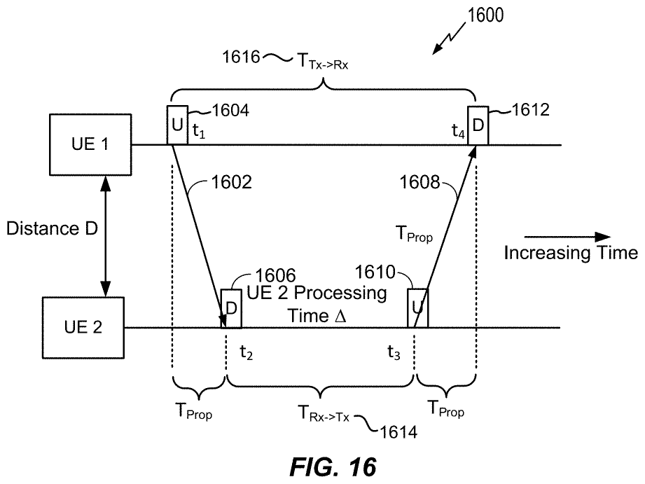

FIG. 16 is a diagram 1600 showing exemplary timings of RTT measurement signals exchanged between UE 1 and UE 2 in accordance with an example implementation of the processes 1400-1500 of FIGS. 14-15, respectively, according to aspects of the disclosure.

In the example of FIG. 16, UE 1 sends a reference signal 1602 (e.g., SRS, SRS-P, SL-RS, etc.) to UE 2 on UL symbol 1604 at time t₁. In this case, the reference signal 1602 functions as both a CLI measurement signal and an RTT measurement signal. The reference signal 1602 has some propagation delay T_{Prop} as it travels from UE 1 to UE 2. At time t₂ (the ToA of the reference signal 1602 at the UE 2), UE 2 receives/measures the ToA (t₂) of the reference signal 1602 on D symbol 1606, and also performs a CLI measurement of the reference signal 1602. After some UE processing time, UE 2 transmits a reference signal 1608 on uplink symbol 1610 at time t₃. The reference signal 1608 functions as both an RTT response signal and a CLI measurement signal. The reference signal 1608 has some propagation delay T_{Prop} as it travels from UE 2 to UE 1. At time t₄ (the ToA of the reference signal 1608 at the UE 1), UE 1 receives/measures the ToA (t₄) of the reference signal 1608 on D symbol 1612, and also performs a CLI measurement of the reference signal 1608. The manner in which the ToAs can be identified is discussed above with respect to FIG. 10, and may likewise be used here with respect to FIG. 16, and as such will not be described further for the sake of brevity.

In some designs, the reference signal 1608 may explicitly include the difference between time t₃ and time t₂ (i.e., T_{Rx→Tx} 1614). Using this measurement and the difference between time t₄ and time t₁ (i.e., T_{Tx→Rx} 1616), UE 1, UE 2, or a network component (e.g., BS 304, LMF, etc.) can calculate the distance between UE 1 and UE 2 as:

$$d = \frac{1}{2 c} ( {T}_{T x \to R x} - {T}_{R x \to T x} ) = \frac{1}{2 c} ( {t}_{2} - {t}_{1} ) - \frac{1}{2 c} ( {t}_{4} - {t}_{3} )$$

where c is the speed of light. While not illustrated expressly in FIG. 16, an additional source of delay or error may be due to UE hardware group delay for position location.

Referring to FIG. 16, it will be appreciated that the symbols (or resources) 1604, 1606, 1610 and 1612 may be part of a reciprocal CLI resource configuration, similar to a legacy CLI measurement procedure. However, UEs 1 and 2 are further configured to perform the above-noted RTT measurements on these symbols, thus opportunistically leveraging these symbols not only to measure CLI, but to measure RTT as well.

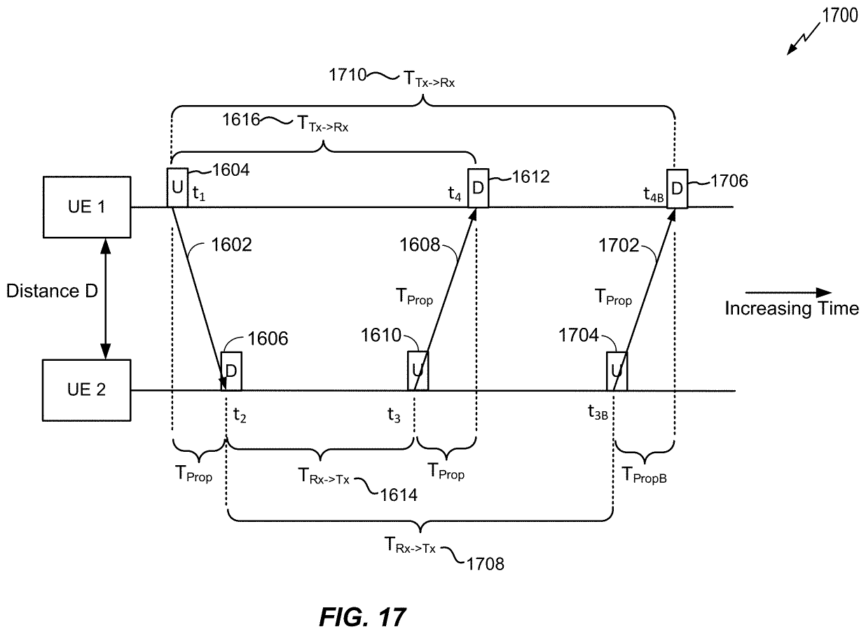

FIG. 17 is a diagram 1700 showing exemplary timings of RTT measurement signals exchanged between UE 1 and UE 2 in accordance with another example implementation of the processes 1400-1500 of FIGS. 14-15, respectively, according to aspects of the disclosure. The diagram 1700 is an extended version of the diagram 1600 of FIG. 16 whereby an additional RTT measurement is made.

In FIG. 17, aspects 1602-1616 are implemented as described above with respect to FIG. 16 for a first RTT measurement. In FIG. 17, after some additional UE processing time, UE 2 transmits another reference signal 1702 on uplink symbol 1704 at time t_{3B}. The reference signal 1702 functions as both an RTT response signal (to the reference signal 1602) and a CLI measurement signal. The reference signal 1702 has some propagation delay T_{Prop} as it travels from UE 2 to UE 1. At time t_{4B} (the ToA of the reference signal 1702 at the UE 1), UE 1 receives/measures the ToA (t_{4B}) of the reference signal 1702 on D symbol 1706, and also performs a CLI measurement of the reference signal 1702. The manner in which the ToAs can be identified is discussed above with respect to FIG. 10, and may likewise be used here with respect to FIG. 17, and as such will not be described further for the sake of brevity.

In some designs, the reference signal 1702 may explicitly include the difference between time t_{3B} and time t₂ (i.e., T_{Rx→Tx} 1708). Using this measurement and the difference between time t₄ and time t₁ (i.e., T_{Tx→Rx} 1710), UE 1, UE 2, or a network component (e.g., BS 304, LMF, etc.) can calculate the distance between UE 1 and UE 2 as:

$$d = \frac{1}{2 c} ( {T}_{T x \to R x} - {T}_{R x \to T x} ) = \frac{1}{2 c} ( {t}_{2} - {t}_{1} ) - \frac{1}{2 c} ( {t}_{4} - {t}_{3} )$$

where c is the speed of light. While not illustrated expressly in FIG. 17, an additional source of delay or error may be due to UE hardware group delay for position location.

Referring to FIG. 17, it will be appreciated that the symbols (or resources) 1604, 1606, 1610, 1612, 1704 and 1706 may be part of a reciprocal CLI resource configuration, similar to a legacy CLI measurement procedure. However, UEs 1 and 2 are further configured to perform the above-noted RTT measurements on these symbols, thus opportunistically leveraging these symbols not only to measure CLI, but to measure RTT as well.

Referring to FIGS. 16-17, in some designs, a first pair of reciprocal CLI resources for RTT can be associated with an initiator UE (e.g., 1604 and 1612, or 1604 and 1706) and a second pair of reciprocal CLI resources for RTT can be associated with a responder UE (e.g., 1606 and 1610, or 1606 and 1704). Each pair of resources is associated with one RTT measurement procedure. As shown in FIG. 17, pairs of resources may overlap in part (e.g., 1604-1606 are used as part of two different reciprocal CLI resource pairs for RTT). In some designs, a pattern may be defined in the reciprocal CLI resource configuration for RTT estimation. Such a pattern may comprise multiple paired resources for RTT (e.g., as shown in FIG. 17 with respect to two resource pairs, facilitating two distinct RTT measurements). The manner in which two resources are paired in this manner can occur in a variety of ways. For example, an adjacent Tx (U) and Rx (D) resource can be organized as a reciprocal CLI resource pair for RTT. In another example, a time anchor may be defined (e.g., t₁). In this case, different time offsets can be defined, whereby a resource associated with the time anchor is paired with a resource associated with each respective time offset from the time anchor. In some designs, the responder UE of each resource pair can be configured to report its time difference (i.e., T_{Rx→Tx} or t₃−t₂), although the initiator UE of each resource pair could alternatively report its time difference (i.e., T_{Tx→Rx} or t₄−t₁) in some designs. In some designs, multiple RTT measurements as shown in FIG. 17 may be implemented to reduce distance estimation error (e.g., RTT measurements can be averaged, etc.).

Referring to FIGS. 13-17, in some designs, the RTT estimation can occur in a variety of ways. In some designs, assisting (or responding) UE may measure the time T₂ and T₃ and get the time difference T_{Rx→Tx}=T₃−T₂. In some designs, the initiator (or positioning) UE may measure the time T₁ and T₄ and get the time difference T_{Tx→Rx}=T₄−T₁. For UE-based RTT estimation, the responding UE may feedback the Rx-Tx time difference to the network, and the network may deliver the time difference to the initiator UE. Alternatively, the responder UE may feedback the Rx-Tx time difference to the initiator UE via sidelink (e.g., for low-latency and power savings, where network interaction is bypassed). In this case, the initiator UE may calculate the RTT between the two UEs. In other designs, network-based (e.g., BS-based or LMF-based) CLI positioning may be implemented. In this case, the initiator and responder UEs feedback their respective time differences to the network, and the network may then deliver the estimated RTT back to the initiator and/or responder UEs. The RTT calculation can be made with respect to algorithms that have already been described above, e.g.:

$$d = \frac{1}{2 c} ( {T}_{T x \to R x} - {T}_{R x \to T x} ) = \frac{1}{2 c} ( {t}_{2} - {t}_{1} ) - \frac{1}{2 c} ( {t}_{4} - {t}_{3} )$$

Referring to FIGS. 14-17, in some designs, range information may be derived between the two UEs based on the estimated UE. In some designs, the range information may help a victim UE manage interference with an aggressor UE. In some designs, a UE may derive relative position information between the two UEs based on the estimated RTT and angle information (e.g., AoD/AoA). In some designs, the angle information may be provided by the network. In other designs, the angle information may be estimate independently at the UE. In some designs, the network may deliver position information of the assisting (responder) UE to the positioning (initiator) UE. In some designs, based on the position information of the assisting UE(s), and the corresponding estimated RTT(s), the positioning UE may derive its own position information. In some designs, the position information may be received (and RTT may be derived for) at least three assisting UEs (e.g., as shown in FIG. 13).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a DSP, an ASIC, an FPGA, or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of operating a first user equipment (UE), comprising:
receiving a reciprocal cross-link interference (CLI) measurement resource configuration associated with the first UE and a second UE; and
performing both a CLI measurement procedure and a round-trip time (RTT) measurement procedure with the second UE based on resources associated with the reciprocal CLI measurement resource configuration.

2. The method of claim 1, wherein the RTT measurement procedure comprises:
transmitting, on a first resource associated with the reciprocal CLI measurement resource configuration, a first reference signal for positioning to the second UE;
measuring a first time associated with the transmission of the first reference signal for positioning;
receiving, in response to the transmitting on a second resource associated with the reciprocal CLI measurement resource configuration, a second reference signal for positioning from the second UE; and
measuring a second time associated with the reception of the second reference signal for positioning.

3. The method of claim 2, further comprising:
reporting timing measurement information associated with the first and second measured times.

4. The method of claim 3, wherein the reporting reports the timing measurement information to the second UE.

5. The method of claim 3, wherein the reporting reports the timing measurement information to a base station.

6. The method of claim 5, further comprising:
receiving, from the base station based in part on the reported timing measurement information, an indication of an RTT associated with the RTT measurement procedure.

7. The method of claim 2, further comprising:
receiving, from the second UE, timing measurement information associated with a delay from a third time at which the first reference signal for positioning is received at the second UE and a fourth time at which the second reference signal for positioning is transmitted from the second UE; and
calculating an RTT between the first UE and the second UE based on the first time, the second time, and the timing measurement information.

8. The method of claim 1, wherein the RTT measurement procedure comprises:
receiving, on a first resource associated with the reciprocal CLI measurement resource configuration, a first reference signal for positioning from the second UE;
measuring a first time associated with the reception of the first reference signal for positioning;
transmitting, in response to the receiving on a second resource associated with the reciprocal CLI measurement resource configuration, a second reference signal for positioning to the second UE; and
measuring a second time associated with the transmission of the second reference signal for positioning.

9. The method of claim 8, further comprising:
reporting timing measurement information associated with a delay from the first measured time to the second measured time.

10. The method of claim 9, wherein the reporting reports the timing measurement information to the second UE.

11. The method of claim 9, wherein the reporting reports the timing measurement information to a base station.

12. The method of claim 11, further comprising:
receiving, from the base station based in part on the reported timing measurement information, an indication of an RTT associated with the RTT measurement procedure.

13. The method of claim 1, wherein the RTT measurement procedure is associated with an exchange of reference signals between the first and second UEs.

14. The method of claim 13, wherein the reference signals comprise a sounding reference signal (SRS), sounding reference signal for positioning (SRS-P), a sidelink reference signal (SL-RS), or a combination thereof.

15. The method of claim 1,
wherein the RTT measurement procedure comprises a plurality of RTT measurements,
wherein each of the plurality of RTT measurements is associated with a pair of resources.

16. The method of claim 15, wherein, for each pair of resources, the pair of resources is paired based on being adjacent resources associated with a different configured receive-transmit direction.

17. The method of claim 15, wherein, for each pair of resources, the pair of resources is paired based on a first resource being associated with an anchor time and a second resource being associated with an offset from the anchor time.

18. A method of operating a base station, comprising:
determining a reciprocal cross-link interference (CLI) measurement resource configuration associated with a first user equipment (UE) and a second UE, the reciprocal CLI measurement resource configuration comprising resources associated with both a CLI measurement procedure and a round-trip time (RTT) measurement procedure between the first UE and the second UE; and
transmitting the reciprocal CLI measurement resource configuration to the first UE and the second UE.

19. The method of claim 18, further comprising:
receiving, from the first and second UEs, timing measurement information associated with the RTT measurement procedure.

20. The method of claim 19, further comprising:
obtaining an RTT based on the received timing measurement information; and
transmitting the RTT to at least one of the first and second UEs.

21. The method of claim 18, wherein the RTT measurement procedure is associated with an exchange of reference signals between the first and second UEs.

22. The method of claim 21, wherein the reference signals comprise a sounding reference signal (SRS), a sounding reference signal for positioning (SRS-P), a sidelink reference signal (SL-RS), or a combination thereof.

23. The method of claim 18,
wherein the RTT measurement procedure comprises a plurality of RTT measurements,
wherein each of the plurality of RTT measurements is associated with a pair of resources.

24. The method of claim 23, wherein, for each pair of resources, the pair of resources is paired based on being adjacent resources associated with a different configured receive-transmit direction.

25. The method of claim 23, wherein, for each pair of resources, the pair of resources is paired based on a first resource being associated with an anchor time and a second resource being associated with an offset from the anchor time.

26. A first user equipment (UE), comprising:
means for receiving a reciprocal cross-link interference (CLI) measurement resource configuration associated with the first UE and a second UE; and
means for performing both a CLI measurement procedure and a round-trip time (RTT) measurement procedure with the second UE based on resources associated with the reciprocal CLI measurement resource configuration.

27. A base station, comprising:
means for determining a reciprocal cross-link interference (CLI) measurement resource configuration associated with a first user equipment (UE) and a second UE, the reciprocal CLI measurement resource configuration comprising resources associated with both a CLI measurement procedure and a round-trip time (RTT) measurement procedure between the first UE and the second UE; and
means for transmitting the reciprocal CLI measurement resource configuration to the first UE and the second UE.

28. A first user equipment (UE), comprising:
a memory;
at least one communications interface; and
at least one processor communicatively coupled to the memory, the at least one communications interface, the at least one processor configured to:
receive a reciprocal cross-link interference (CLI) measurement resource configuration associated with the first UE and a second UE; and
perform both a CLI measurement procedure and a round-trip time (RTT) measurement procedure with the second UE based on resources associated with the reciprocal CLI measurement resource configuration.

29. A base station, comprising:
a memory;
at least one communications interface; and
at least one processor communicatively coupled to the memory, the at least one communications interface, the at least one processor configured to:
determine a reciprocal cross-link interference (CLI) measurement resource configuration associated with a first user equipment (UE) and a second UE, the reciprocal CLI measurement resource configuration comprising resources associated with both a CLI measurement procedure and a round-trip time (RTT) measurement procedure between the first UE and the second UE; and
transmit the reciprocal CLI measurement resource configuration to the first UE and the second UE.

30. A non-transitory computer-readable medium containing instructions stored thereon, which, when executed, cause a first user equipment (UE) to:
receive a reciprocal cross-link interference (CLI) measurement resource configuration associated with the first UE and a second UE; and
perform both a CLI measurement procedure and a round-trip time (RTT) measurement procedure with the second UE based on resources associated with the reciprocal CLI measurement resource configuration.

31. A non-transitory computer-readable medium containing instructions stored thereon, which, when executed, cause a base station to:
determine a reciprocal cross-link interference (CLI) measurement resource configuration associated with a first user equipment (UE) and a second UE, the reciprocal CLI measurement resource configuration comprising resources associated with both a CLI measurement procedure and a round-trip time (RTT) measurement procedure between the first UE and the second UE; and
transmit the reciprocal CLI measurement resource configuration to the first UE and the second UE.
